(19) United States
(12) Patent Application Publication
(10) Pub. No.: US 2005/0160846 A1
(43) Pub. Date: Jul. 28, 2005

(54) Linear actuator

(76) Inventor: Yi-Chung Chiang, Sindian City (TW)

Correspondence Address: Yi-Wen Tseng, 4331 Stevens Battle Lane, Fairfax, VA, 22033, US

(21) Appl. No.: 10/759,148

(22) Filed: Jan. 20, 2004

(51) Int. Cl. F16H 3/06

(52) U.S. Cl. 74/89.35

(57) ABSTRACT

A linear actuator has two half-shells, a motor housing, a motor installed in the motor housing, a guiding screw driven by the motor, a screw nut engaged with the guiding screw, an interior tube encircling the guiding screw and connected with the screw nut at one end thereof, a moveable exterior tube telescoping the interior tube therein, at least two ball bearings subject to radial and axial load, and fitting seat installed in the half-shells. The fitting seat has to bearing seats for mounting the ball bearings, such that the load capacity of the linear actuator is increased, while the application safety is enhanced.

### BACKGROUND OF THE INVENTION

The present invention relates to a linear actuator, and more particular, to a linear actuator with increased load capacity, enhanced application safety and smooth actuation.

A linear actuator is a structure which uses an assembly of a motor, a gear and a connection rod to actuate rotation of a guiding screw, so as to provide linear extension and retraction of an interior tube. Thereby, extension or retraction motion is generated. The actuator has been commonly applied in sick beds, elevators, or other devices requiring extension and retraction motions.

In the typical linear actuator, the load of the guiding screw is applied to an axial bearing (anti-thrust bearing). As the axial bearing can carry the axial load of the guiding screw only, the load capacity of the actuator is very limited. Otherwise, overload of the actuator may cause safety concern.

### BRIEF SUMMARY OF THE INVENTION

The present invention provides a linear actuator includes two ball bearings operative to withstand the radial load and axial load, respectively. Therefore, the load capacity of the linear actuator is increased; and consequently, the application safety is enhanced. In addition, the anti-thrust and retraction motion can be more smoothly actuated.

The linear actuator provided by the present invention includes two half-shells joined together to form a chamber, a motor housing protruding from one of the half-shells and in communication with the chamber, a motor installed in the motor housing to actuate a motor shaft. The motor shaft includes a worm. The linear actuator further includes a guiding screw with a threaded section and a fitting section linearly connected to each other. The fitting section includes a worm gear intermeshed with the motor shaft. The fitting section extends into the chamber and is mounted to a rear arm protruding from a rear side of the two half-shells. The threaded section extends from a front side of the two half-shells and is threaded with a screw nut. An interior tube encircles the guiding structure has a rear end connected to the screw nut. The interior tube includes a linking member at a front end thereof. An exterior tube telescopically receives the interior tube therein. The rear end of the exterior tube extends into the chamber, while the front end of the exterior tube allows the linking member to protrude out of the chamber. The linear actuator further comprises at least two ball bearings installed in the fitting section before and after the worm gear. A fitting seat is installed in the chamber allowing the fitting section to penetrate through. The fitting seat includes a hollow worm gear seat and two hollow bearing seats for mounting the worm gear and the ball bearings therein.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows a perspective view of the linear actuator provided by the present invention;

FIG. 2 shows an exploded view of the linear actuator; and

FIG. 3 shows a cross-sectional view of the actuator.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

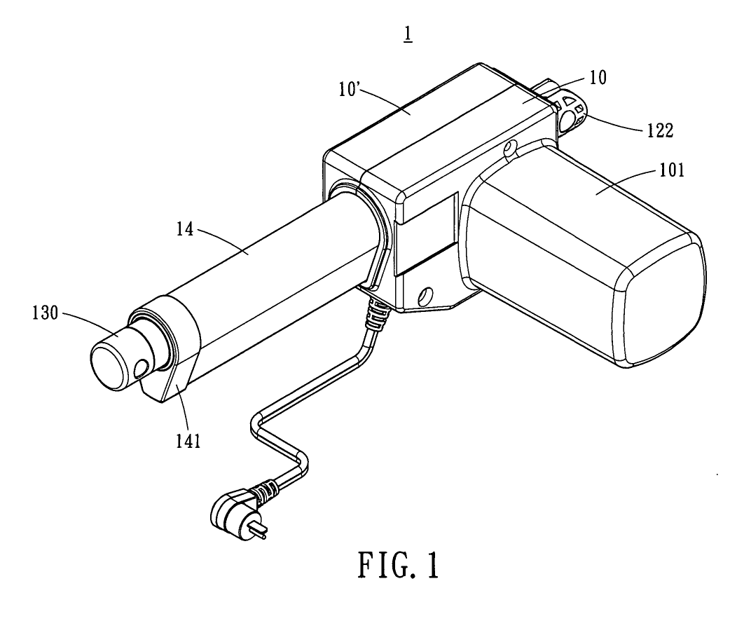

Referring to FIGS. 1-3, the perspective view, exploded view and cross-sectional view of a linear actuator are illustrated. As shown, the linear actuator 1 includes two half-shells 10 and 10′ joined together to form a chamber 100. One side of the half-shell 10 extends outwardly to form a motor housing 101. A reversible electric motor 11 is installed in the motor housing 101. As the motor housing 101 is in communication with the chamber 100, the motor shaft 110 driven by the motor 11 extends into the chamber 100. The half-shells 10 and 10′ provide the water and dust proof to the motor 11 and motor shaft 110. The motor shaft 110 includes a worm, for example.

The motor 11 is operative to actuate rotation of a guiding screw 12 via the motor shaft 110. The guiding screw 12 includes a threaded section 120 and a fitting section 121 connected to each other in a line. The fitting section 120 includes a worm gear 123 to be intermeshed with the motor shaft 110 of the motor. The fitting section 120 extends into the chamber 100 constructed by the half-shells 10 and 10′. The rear end of the fitting section 120 is mounted to a rear arm 122. The threaded section 121 extends from the front end of the half-shells 10 and 10′, while the arm 122 extends from the rear end of the half-shells 10 and 10′, such that the rear arm 122 can be pivotally connected with an external device to fit the linear actuator 1 thereto. The threaded section 120 of the guiding screw 12 includes a screw nut 124.

The guiding screw 12 is actuated by the motor 11 to rotate, such that the screw nut 124 engaged with the threaded section 120 can drive an interior tube 13 to perform thrust or retraction motions. The interior tube 13 encircling the guiding screw 12 includes a connection member 130 formed at a front end thereof. The connection member 130 is connected to an object to be lifted or descended by the actuator 1. A rear end of the interior 13 is connected to the screw nut 124. Therefore, when the motor 11 actuates the guiding screw 12 to rotate, the screw nut 124 performs a linear axial displacement, which drives a thrust or retraction movement of the interior tube 13. The thrust or retraction movement of the interior tube 13 can be applied to lift or descend a carrier such as a sick bed or other devices.

The interior tube 13 is telescopically received by an exterior tube 14. The exterior tube 14 includes an exterior tube sleeve 140 extending into the chamber 100. The front end of the exterior tube 14 allows the connection member 130 of the interior tube 13 to protrude outside of the chamber 100. The front end of the exterior tube 14 further comprises a fitting lid 141 to support the stability and fluency of the displacement of the interior tube 13. Thereby, bend and deformation of the extended interior tube 13 caused by the load are reduced. The fitting lid 141 further provides dust and water proof effect.

The actuator 1 further comprises at least two ball bearings 15 and 15′ to withstand radial and axial load, so as to increase the load capacity and application safety thereof. The ball bearings 15 and 15′ are installed at the fitting section 121 of the guiding screw 12. The bearings 15 and 15′ are located in front and behind the worm 123. The bearings 15 and 15′ have different sizes. The actuator 1 may further includes a fitting seat 16 through which the fitting section 121 of the guiding screw 12 extends. The fitting seat 16 is assembled by two half-shells, in which a worm gear seat 160 and two bearing seats 161 and 161′ are formed for fitting the worm gear 123 and the ball bearings 15 and 15′ therein. The front and rear ends of the fitting seat 16 are connected with the exterior tube sleeve 140 and the rear arm 122, respectively. Therefore, the stability of the guiding screw 12 is further enhanced.

Thereby, the linear actuator mechanism according to the present invention is constructed.

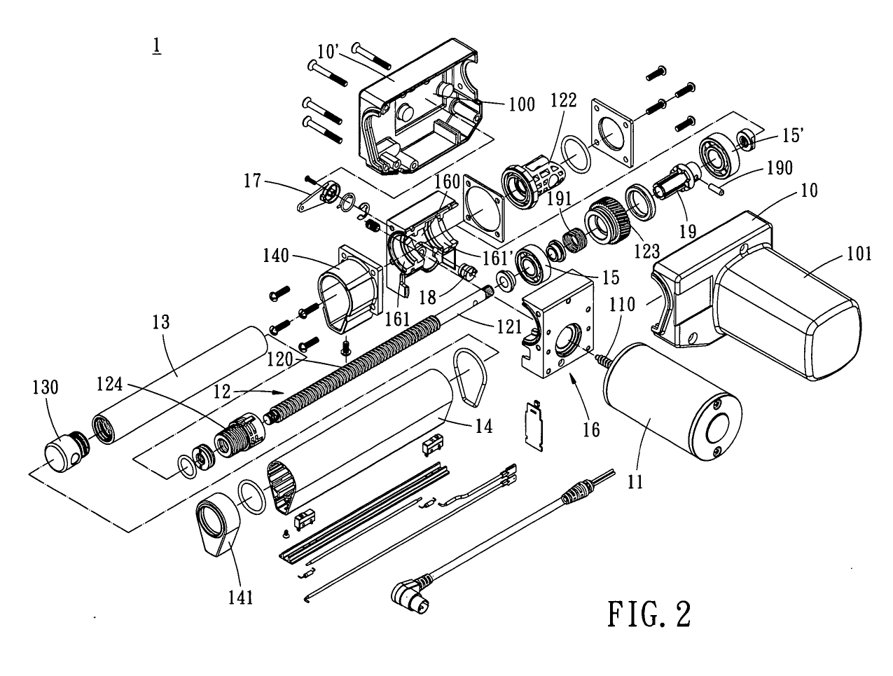

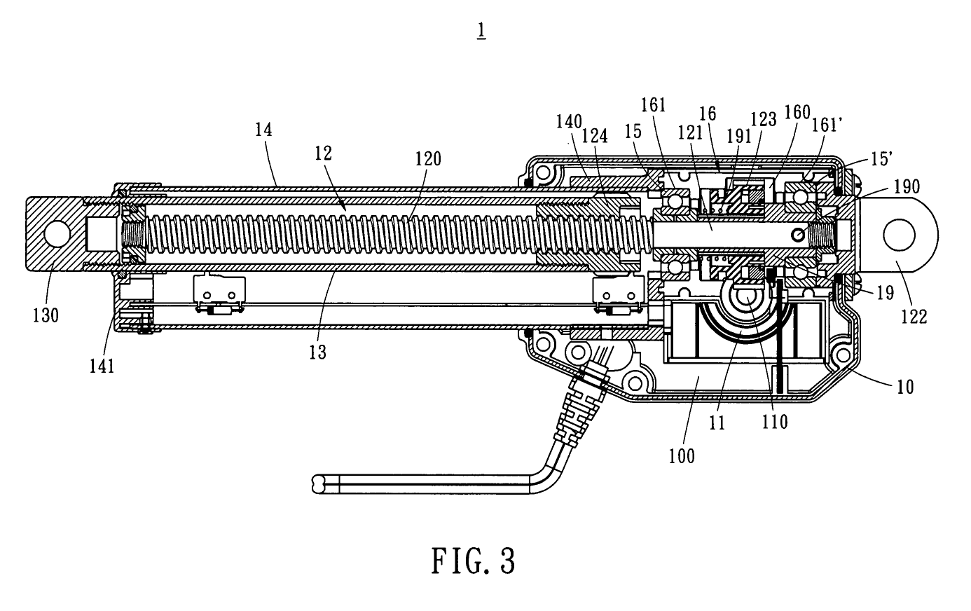

As shown in FIGS. 2 and 3, the actuator 1 may also comprises a control member 17, an interlock member 18 connected to the control member 19, and a clutch member 19 to perform in and out of gear motions with the worm gear 123. The clutch member 19 is installed at the fitting section 121 of the guiding screw 12 and can be fitted to one proximal end of the worm gear 123 by bolting device 190. The distal end of the worm gear 123 may includes as elastic member 191 of which the tension is adjustable to change the load capacity. By controlling movement of the interlock member 18, the worm gear 123 is displaced along the axis of the fitting section 121 of the guiding screw 12. The clutch member 19 connected to the worm gear 123 is disengaged with the worm gear 123. Thereby, when the actuator is suddenly out of electricity supply or when the motor 11 is out of order, the interior tube 13 of the actuator 1 can be instantly displaced and resumed to the original orientation and position.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A linear actuator, comprising:
two half-shells joined together to form a chamber;
a motor housing extending outwardly from one of the half-shells, the motor housing being in communication with the chamber;
a motor installed in the motor housing for driving a motor shaft extending towards into the chamber, the motor shaft including a worm;
a guiding screw having a threaded section and a fitting section connected as a line, wherein the threaded section includes a worm gear to be intermeshed with the motor shaft, the fitting section extends into the chamber to be mounted to a rear arm extending out of the half-shells from a rear end thereof, and the threaded section extends out of the half-shells from a front end thereof, the threaded section includes a screw nut;
an interior tube encircling the guiding screw and having a rear end connected to the screw nut, the interior tube including a connection member at a front end thereof;
an exterior tube telescopically receiving the interior tube therein, the exterior tube having a rear end extending into the chamber and a front end allowing the connection member to extend out of the chamber;
at least two ball bearings installed in the fitting section at two sides of the worm gear; and
a fitting seat installed in the chamber allowing the fitting section to extend through, the fitting seat including a worm gear seat and two bearing seats for receiving the worm gear and the ball bearings therein.

2. The actuator of claim 1, wherein the ball bearings have different sizes.

3. The actuator of claim 1, wherein the fitting seat has a front end connected to an exterior tube sleeve which receiving the rear end of the exterior tube therein.

4. The actuator of claim 3, wherein the fitting seat has a rear end connected to the rear arm.

5. The actuator of claim 3, wherein the front end of the exterior tube further comprises a fitting lid to cover the interior tube.

6. The actuator of claim 1, wherein the fitting seat has a rear end connected to the rear arm.

7. The actuator of claim 1, wherein the front end of the exterior tube further comprises a fitting lid to cover the interior tube.

8. The actuator of claim 1, further comprising a control member, an interlock member connected to the control member and a clutch member to be engaged and disengaged with the worm gear, wherein the clutch member is installed at the fitting section and fitted at a proximal end of the worm gear, while a distal end of the worm gear includes a resilient member.

9. The actuator of claim 8, wherein the clutch member is fitted at the fitting section by a fitting member.

10. The actuator of claim 9, wherein the fitting member includes a bolt.

11. The actuator of claim 8, wherein the resilient member includes spring.
